(19) United States
(12) Patent Application Publication
(10) Pub. No.: US 2010/0006216 A1
(43) Pub. Date: Jan. 14, 2010

(54) APPARATUS, DEVICE METHOD FOR RUBBER-COATING OF CUTTING DIES

(76) Inventor: Paolo Lombardo, Scandicci (IT)

Correspondence Address: J David Dainow;Abelman, Frayne & Schwab, 666 Thiird Avenue, 10th Floor, New York, NY, 10017-5621, US

(21) Appl. No.: 12/448,706

(22) PCT Filed: Dec. 27, 2007
(86) PCT No.: PCT/IB2007/004112

§ 371 Date: Jun. 29, 2009

(30) Foreign Application Priority Data
Dec. 29, 2006 (IT) FI2006A000342

(51) Int. Cl. B32B 37/02

(52) U.S. Cl. 156/250; 156/510

(57) ABSTRACT

An apparatus, device and method for automatically rubber-coating cutting dies comprising: elastic material containing and distributing means (10); cutting and positioning means (13, 14) of portions of said elastic material (100); supporting and handling means of said elastic material containing and distributing means and of said cutting and positioning means of portions of said elastic material.

### FIELD OF THE INVENTION

The present invention relates to the field of machine tool accessories.

### STATE OF THE ART

As known, cutting dies are devices which allow to cut materials in sheet form into different shapes.

The cutting die essentially consists of a strip of metal (called rule) mounted on a specific flat or curved support in which—for example by means of specific numeric control laser cutters—the seat for said metal strip is engraved following the contours of the desired shape. After having been engraved, the metal strip (the so-called rule) is inserted, again automatically, so that its cuffing edge perpendicularly protrudes from the support. If said support is not flat, the rule will protrude from its convex side.

By placing any material in sheets over the rule and exerting an appropriate pressure on it, e.g. with a flat press in the case of a flat support or with a cylinder in case of a curved support, it is possible to cut out a shape in the sheet coinciding with the surface enclosed by the rule.

However, since due to the pressure the cut-out shapes would tend to sink with respect to the rule making them difficult to collect, a strip of elastic material, e.g. rubber, is arranged on the rule support, along the rule itself and on both sides thereof, which after performing the cut moves the cut piece upwards thus allowing an easy manual or mechanical collection thereof.

All the cutting die construction operations are automatically performed without the intervention of manual operators, except for the rubber application which is instead manually performed by firstly applying a layer of adhesive along the internal and external edge of the rule, and then making a rubber band or thread of the desired thickness and elasticity adhere to it.

It is apparent that this operation, employing an operator, is long-lasting and expensive and it is also apparent the advantage which would be obtained if this operation could be automated, thus automating the entire cutting die production process from the initial laser cutting of the support to indeed the rubber coating.

Furthermore, the automatic die cutting machines of the known art, which may produce even up to 10,000/12,000 sheets/hour, in order to prevent the formation of detrimental air cushions, which could displace the sheet to be die-cut thus loosing the necessary die cutting accuracy, must ensure that whenever the pressing bed of the die cutting machine is lowered onto the cutting die, all the air which is created by the movement of the bed itself is expelled as rapidly as possible. This does not occur when the rubber forms a double barrier and the available solution, in these cases, is only to reduce the die cutting machine speed, sometimes even by 40%.

In the field of the production of cutting dies it is also known to use plotters, devices essentially consisting of a trolley capable of moving on a flat surface according to Cartesian coordinates (x, y), said trolley being equipped with a specific tool which allows to perform the desired operations, e.g. a pen (for printing), a blade (for carving), a milling cutter (for engraving), etc.

In this manner, by controlling the tool movements along the Cartesian axes, it is possible to draw lines, spots, curves, etc. with it.

Specifically, there are known plotters in which the tool consists of a (hot or cold) glue gun which are thus capable of distributing the glue on the concerned surface in points determined by the operator and thus apply the glue needed for the step of rubber-coating.

### SUMMARY OF THE INVENTION

The present invention relates to a device and a method which allow the automatic rubber-coating of an either flat or curved cutting die and which may possibly be associated to a plotter or to a tooled robot arm for automatic glue application or handling.

### BRIEF DESCRIPTION OF THE DRAWINGS

FIG. 1 diagrammatically shows a perspective view of the device according to the invention.

FIG. 2 diagrammatically shows a plan view of the device according to the invention fitted on the arm of a plotter.

### DETAILED DESCRIPTION OF THE INVENTION

The present invention allows to overcome the aforesaid problem in virtue of a device and a method capable of automatically distributing the rubber or similar material, making it adhere to the cutting die support along the entire rule and on both sides thereof, and so that the previously described problems are solved, specifically using separate rubber plugs adapted to be compressed more than an equivalent rubber surface cut into a strip according to the traditional method. The advantage which derives therefrom is a higher elasticity to the benefit of the sheet lifting and, moreover, the high compression capacity of the rubber plug solves the problem of overpressure which the traditional rubber in strips creates on soft material sheet, such as for example corrugated cardboard, precisely due to the limited compression power.

The device according to the invention comprises elastic material containing and distributing means, preferably in the form of cylindrical section segments or in the form of ribbon; cutting and positioning means of portions of said elastic material and supporting and handling means of said elastic material containing and distributing means and of said cutting and positioning means of portions of said elastic material.

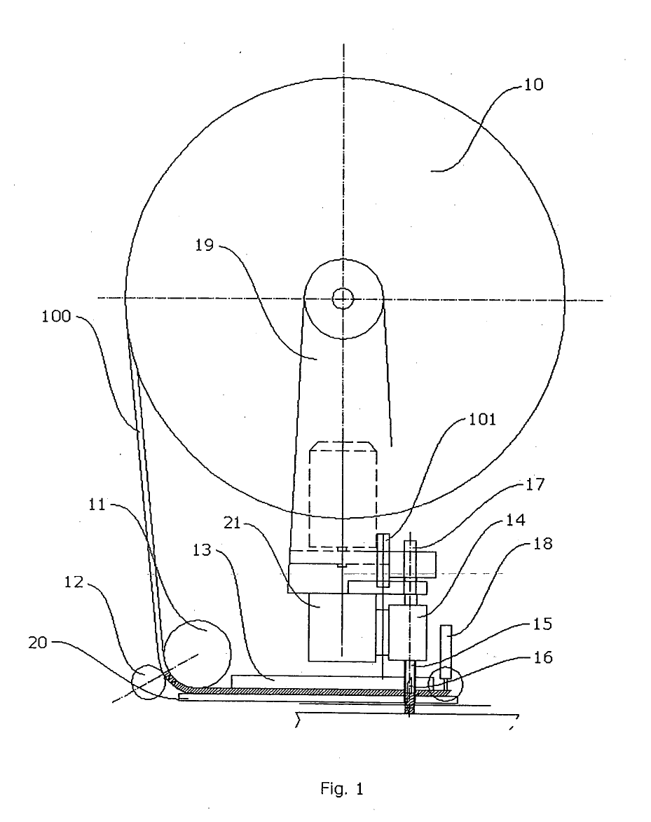

FIG. 1 shows a preferred but not limiting embodiment of the device according to the present invention. Said elastic material containing and distributing means comprise at least one first distributing reel 10 loaded with an elastic material strip 100 with which the cutting die will be rubber-coated and at least one applicator of said elastic material strip on a plane perpendicular to that of said first distributing reel, comprising at least one feeding roller 11 and at least one counter roller 12, preferably coated with non-slip material, e.g. rubber, and associated to appropriate handling means 102, or comprising at least two feeding belts, fitted in front of each other on opposite sides with respect to the said elastic material and along the parallel sides orthogonal to the sliding plane, said belts being preferably coated with non-slip material, e.g. rubber, and associated to appropriate handling means. Said cutting and positioning means of portions of said elastic material comprise a perforating template 13; a perforating device 14 equipped with at least one hollow tip 15 and corresponding handling means 101 in a direction orthogonal to the plane; extraction means of the material cut by said perforating device 14 and collection and disposal means 18 of possible machining residues. Said hollow tip may have a cylindrical section or any other appropriate section for making elastic material plugs for rubber-coating cutting dies having the required shape. In a first preferred embodiment, said extraction means of the material cut by said perforating device 14 comprise an extractor 16 consisting of a cylinder freely sliding within said hollow tip and corresponding handling means 17 in a direction perpendicular to the cutting die support. Furthermore, said collection and disposal means 18 of possible machining residues comprise a so-called scrap-shearing device associated to an appropriate suction system. Alternatively, said hollow tip with its perforating advancement reaches the counter bed underneath and forms the rubber plug therein, it is then lifted to allow the rubber ribbon to advance. As the hollow tip is lifted, the formed rubber plug would tend to be lifted along with the hollow tip itself but this does not occur in virtue of a fixed cylindrical pin inside said hollow tip which forces the rubber plug to remain inside the rubber ribbon while the hollow tip is being lifted. The rubber ribbon may thus advance by one step, with the formed rubber plug therein, which will be thus extracted and positioned on the cutting die during the subsequent step. The cylindrical extractor is positioned at an appropriate distance, e.g. at a distance of two steps, from the hollow tip in the advancement direction of the rubber.

In a second preferred embodiment, said extraction means of the material cut by said perforating device 14 comprise a second reel for recovering the scrap rubber strip.

Preferably, the device according to the present invention comprises a bearing support 19, 20 possibly equipped with anchoring means to the movable arm of a plotter. In a further embodiment of the device according to the present invention, indeed, it may be integrated, specifically, with the arm of a plotter equipped for automatic gluing, so as to make an automatic cutting die rubber-coating apparatus.

In other preferred embodiments of the device according to the present invention, said elastic material containing and distributing means and said cutting and positioning means of portions of said elastic material may be implemented so as to manage elastic materials of different shapes and also in fluid and liquid form.

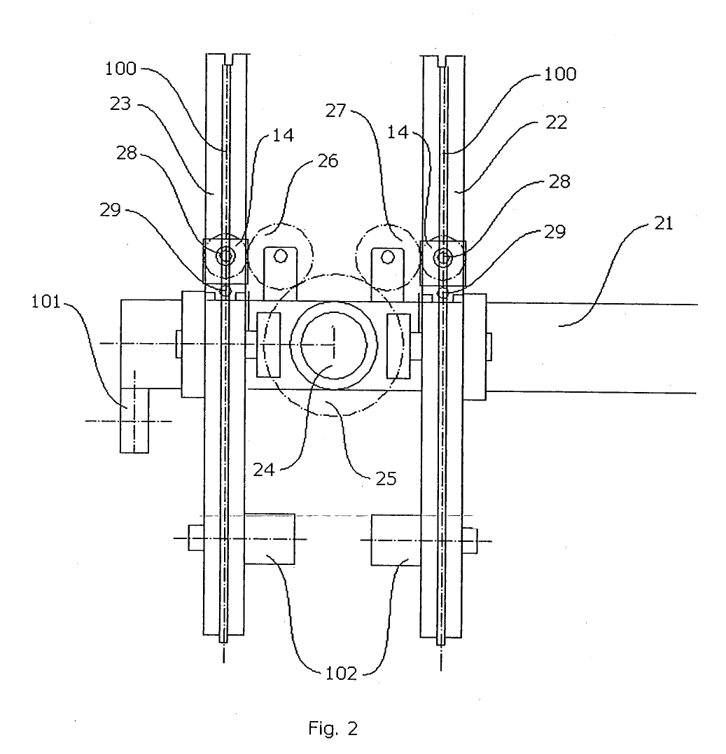

FIG. 2 shows the device according to the present invention integrated with the arm 21 of a automatic gluing plotter equipped with an appropriate glue applying gun 101. In this specific embodiment, there are two reels 22, 23 equipped with a motor 24 associated to appropriate means 25, 26, 27 distributing the rotary motion thereof to said perforating device 14 equipped with the hollow tip 15. Preferably, said appropriate means 25, 26, 27 distributing the rotary motion comprise toothed wheels and drive shafts. Said hollow tip 15 is associated in turn to an extractor cylinder 16 and both are associated to corresponding control and handling cylinders 28, 29. Finally, there are appropriate collection and disposal means 18 of possible machining residues, preferably made by means of a so-called scrap shearing device associated to an appropriate suction system.

During the operation of the device according to the present invention, in the preferred embodiment described in accompanying FIG. 2, the arm of the plotter, appropriately guided by a numeric control system, deposits an appropriate layer of glue on the cutting die support along the entire rule and on both sides thereof. Correspondingly, the device according to the present invention, also integral with said arm of the plotter, automatically deposits the elastic material strip 100 with which to rubber-coat the cutting die, which strip is unwound from said first reel 10, by effect of the action of said at least one feeding roller 11 and at least one counter roller 12, actuated by corresponding handling means 102. Said strip is applied over the glue previously deposited by the plotter and is then cut into a sequence of small cylinder-shaped plugs by effect of the action of said perforating template 13 and of said perforating device 14 equipped with the hollow tip 15 actuated by corresponding handling means 101. At this point, said extraction means of the material cut by said hollow tip, preferably made using an extractor cylinder 16 associated to the corresponding control and handling cylinder 28, correctly place the cylindrical plug onto the cutting die support so that it is adjacent to the rule of the cutting die itself. Subsequently, said collection and disposal means 18 of possible machining residues, preferably made by a so-called scrap-shearing device associated to an appropriate suction system, clean the cutting die from possible scrap produced during the step of cutting the aforesaid plugs.

The above-described operations are supervised and managed by an appropriate computerized control system which manages the displacements of the arm of said plotter and of the various components of the device according to the present invention.

1. A device for rubber-coating cutting dies comprising: means for containing and distributing elastic material such as rubber strips and ribbons; means for cutting and positioning portions of said elastic material, associated to said means for containing and distributing elastic material and adapted to place said elastic material on the cutting die support along the entire rule and on both sides thereof; means for supporting and handling said means for containing and distributing elastic material and said means for cutting and positioning portions of said elastic material.

2. A device according to claim 1, wherein said elastic material containing and distributing means comprise at least one first distributing reel loaded with an elastic material strip with which the cutting die will be rubber-coated and at least one applicator of said elastic material strip on a plane perpendicular to that of said first distributing reel.

3. A device according to claim 2, wherein said at least one applicator comprises at least one feeding roller and at least one counter roller associated to appropriate handling means.

4. A device according to claim 2, wherein said at least one applicator comprises at least two feeding belts, fitted in front of each other on opposite sides with respect to the said elastic material and along the parallel sides orthogonal to the sliding plane, said belts being preferably associated to appropriate handling means.

5. A device according to claim 3, wherein said at least one feeding roller, said at least counter roller and said belts are coated with non-slip material.

6. A device according to claim 1, wherein said cutting and positioning means of portions of said elastic material comprise a perforating template, a perforating device and corresponding handling means in a direction orthogonal to the plane of the cutting die support; extraction means of the material cut by said perforating device and collection and disposal means of possible machining residues.

7. A device according to claim 6, wherein said perforating device comprises at least one hollow tip.

8. A device according to claim 7, wherein said hollow tip has a cylindrical section.

9. A device according to claim 6, wherein said extraction means of the material cut by said perforating device comprise an extractor consisting of a cylinder freely sliding within said hollow tip and corresponding handling means in a direction perpendicular to the plane of the cutting die support.

10. A device according to claim 6, wherein said extraction means of the material cut by said perforating device comprise a fixed cylindrical pin inside said hollow tip.

11. A device according to claim 10, wherein said extraction means of the material cut by said perforating device comprise a cylindrical extractor positioned at an appropriate distance from said hollow tip in the direction of advancement of said elastic material.

12. A device according to claim 11, wherein said cylindrical extractor is positioned at a distance of two steps from said hollow tip in the direction of advancement of the rubber.

13. A device according to claim 6, wherein said extraction means of the material cut by said perforated device comprise a second reel for recovering the scrap rubber strip.

14. A device according to claim 6, wherein said collection and disposal means of possible machining residues comprise a so-called scrap-shearing device associated to an appropriate suction system.

15. A device according to claim 1, wherein it comprises a bearing support.

16. A device according to claim 15, wherein said bearing support comprises appropriate anchoring means to the arm of a robot.

17. A device according to claim 15, wherein said bearing support comprises appropriate anchoring means to the movable arm of a plotter.

18. A device according to claim 17, wherein said plotter is of the type tooled for automatic gluing.

19. A device according to claim 1, wherein it comprises an appropriate control system which manages and controls the various component parts thereof.

20. A plotter apparatus wherein at least one of said movable arms comprises at least one device for automatically rubber-coating cutting dies according to claim 1.

21. An apparatus according to claim 20, wherein at least one of the movable arms comprises: at least one glue applying gun; two distributing reels of elastic material for rubber-coating cutting dies; at least one motor associated to both said distributing reels; at least one perforating device, equipped with a hollow tip, for each of said distributing reels; appropriate means distributing the rotary motion of said at least one motor; at least one extractor cylinder associated to said at least one hollow tip; at least one control and handling cylinder associated to said at least one hollow tip and to at least one said extractor cylinder collection and disposal means of possible machining residues.

22. An apparatus according to claim 21, wherein said collection and disposal means of possible machining residues comprise at least a so-called scrap-shearing device associated to an appropriate suction system.

23. An apparatus according to claim 20, wherein said appropriate means distributing the rotary motion comprise toothed wheels and drive shafts.

24. An apparatus according to claim 20, wherein it comprises an appropriate control system which manages and controls the various component parts thereof.

25. A method for automatically rubber-coating cutting dies comprising the following steps: distributing elastic material such as rubber strips and ribbons on the cutting die support, cutting said elastic material and positioning said elastic material on said cutting die support.

26. A method according to claim 25, wherein said step of cutting said elastic material is such to make separate rubber plugs.

27. A method according to claim 25, wherein it comprises a further step of recovering the machining residue elastic material.

28. A method according to claim 25, wherein said steps of distributing, cutting and positioning the elastic material on the cutting die support are performed by means of the device according to claim 1.
